(19) United States
(12) Patent Application Publication
(10) Pub. No.: US 2024/0208017 A1
(43) Pub. Date: Jun. 27, 2024

(54) Driving Tool

(71) Applicant: Max Co., Ltd., Tokyo (JP)

(72) Inventors: Kousuke Moriwaki, Tokyo (JP); Yoshihlko Kondou, Tokyo (JP)

(21) Appl. No.: 18/393,558

(22) Filed: Dec. 21, 2023

(30) Foreign Application Priority Data
Dec. 22, 2022 (JP) 2022-205722
Nov. 13, 2023 (JP) 2023-192978

(51) Int. Cl. B25C 1/00; B25C 1/04

(52) U.S. Cl. CPC B25C 1/003; B25C 1/047

(57) ABSTRACT

There is provided a driving tool including: a main body portion; and a magazine that includes an accommodation portion configured to accommodate a fastener, and a cap portion that opens and closes the accommodation portion, and the magazine being movable in a first direction approaching the main body portion and a second direction separated from the main body portion. The main body portion includes an engaging portion engageable with the cap portion in a state where the cap portion is closed. The cap portion is engaged with the engaging portion by the magazine moving in the first direction, and is disengaged from the engaging portion by the magazine moving in the second direction from a state of being engaged with the engaging portion.

### CROSS-REFERENCE TO RELATED APPLICATIONS

This application is based on and claims priority under 35 USC 119 from Japanese Patent Application No. 2022-205722 filed on Dec. 22, 2022, and Japanese Patent Application No. 2023-192978 filed on Nov. 13, 2023, the contents of which are incorporated herein by reference.

### TECHNICAL FIELD

The present disclosure relates to a driving tool that includes a magazine capable of accommodating fasteners and that injects the fasteners accommodated in the magazine.

### BACKGROUND ART

A driving tool that injects fasteners such as screws and nails includes a magazine that accommodates the fasteners. The magazine accommodates a fastener connection body in which a plurality of fasteners are connected by a connection band. In such a tool, a nose portion from which the fastener is injected, a magazine cap portion provided in the magazine in order to allow the fastener connection body to be loaded into the magazine, and a door portion provided in the nose portion can be opened and closed, respectively (for example, see JP5482825B).

In the related art, in order to open and close a magazine cap portion provided in a magazine, it is necessary to open and close a door portion provided in a nose portion, and it is necessary to operate another member that holds the magazine cap portion in a closed state. Therefore, it takes time to open and close the magazine cap portion.

### SUMMARY OF INVENTION

The present disclosure provides a driving tool that facilitates an operation of opening and closing a magazine cap portion.

According to an illustrative aspect of the present disclosure, a driving tool includes: a main body portion: and a magazine that includes an accommodation portion configured to accommodate a fastener, and a cap portion that opens and closes the accommodation portion, and the magazine being movable in a first direction approaching the main body portion and a second direction separated from the main body portion. The main body portion includes an engaging portion engageable with the cap portion in a state where the cap portion is closed. The cap portion is engaged with the engaging portion by the magazine moving in the first direction, and is disengaged from the engaging portion by the magazine moving in the second direction from a state of being engaged with the engaging portion.

In the present disclosure, when a magazine is moved in a first direction, a cap portion is engaged with an engaging portion, whereby the cap portion holds an accommodation portion in a closed state. When the magazine is moved in a second direction, the engagement between the cap portion and the engaging portion is released, and the cap portion can be opened and closed.

In the present disclosure, the cap portion and the engaging portion can be engaged and disengaged in an operation of moving the magazine. Accordingly, the cap portion can release the accommodation portion from being held in the closed state in the operation of moving the magazine, and it is not necessary to operate another member that holds the cap portion in the closed state. Therefore, an operation of opening and closing the cap portion of the magazine becomes easy.

### BRIEF DESCRIPTION OF DRAWINGS

FIG. 1A is a side view illustrating an example of a nail gun according to the present embodiment;

FIG. 1B is a side view illustrating the example of the nail gun according to the present embodiment:

FIG. 2A is a perspective view illustrating the example of the nail gun according to the present embodiment:

FIG. 2B is a perspective view illustrating the example of the nail gun according to the present embodiment:

FIG. 3A is a perspective view of a main part illustrating the example of the nail gun according to the present embodiment;

FIG. 3B is a perspective view of a main part illustrating the example of the nail gun according to the present embodiment;

FIG. 4A is a side sectional view illustrating the example of the nail gun according to the present embodiment:

FIG. 4B is a side sectional view illustrating the example of the nail gun according to the present embodiment;

FIG. 5A is a side sectional view of a main part illustrating the example of the nail gun according to the present embodiment:

FIG. 5B is a side sectional view of a main part illustrating the example of the nail gun according to the present embodiment;

FIG. 6A is a bottom sectional view of a main part illustrating the example of the nail gun according to the present embodiment:

FIG. 6B is a bottom sectional view of a main part illustrating the example of the nail gun according to the present embodiment;

FIG. 7A is a sectional perspective view of a main part illustrating the example of the nail gun according to the present embodiment;

FIG. 7B is a sectional perspective view of a main part illustrating the example of the nail gun according to the present embodiment;

FIG. 8 is an exploded perspective view of a main part illustrating the example of the nail gun according to the present embodiment;

FIG. 9A is a perspective view of a main part illustrating an example of a nail gun according to a modification of the present embodiment;

FIG. 9B is a perspective view of a main part illustrating the example of the nail gun according to the modification of the present embodiment;

FIG. 10 is a perspective view of a main part illustrating an example of a nail gun according to a second embodiment:

FIG. 11A is a side view of a main part illustrating the example of the nail gun according to the second embodiment;

FIG. 11B is a side view of a main part illustrating the example of the nail gun according to the second embodiment;

FIG. 12A is a side view of a main part illustrating the example of the nail gun according to the second embodiment; and

FIG. 12B is a side view of a main part illustrating the example of the nail gun according to the second embodiment.

### DESCRIPTION OF EMBODIMENTS

Hereinafter, embodiments of a nail gun as an example of a driving tool of the present disclosure will be described with reference to the drawings.

### <Configuration Example of Nail Gun of Present Embodiment>

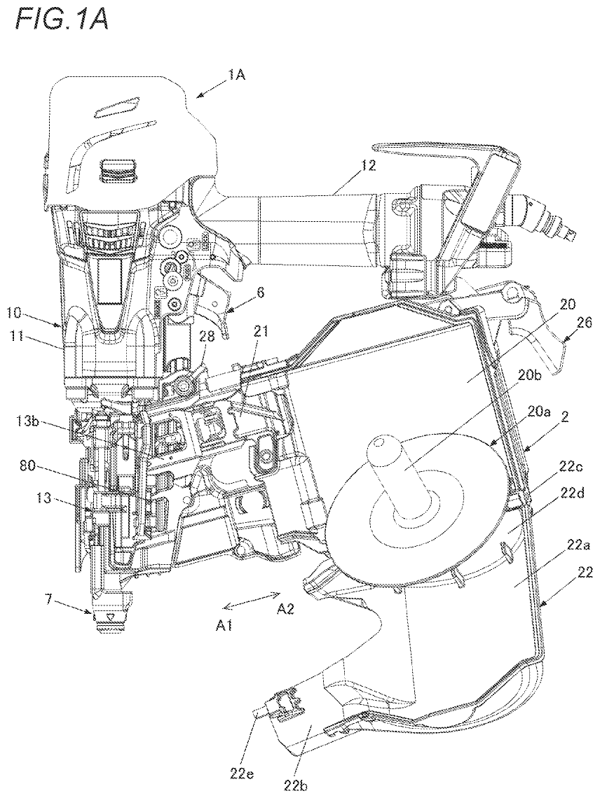

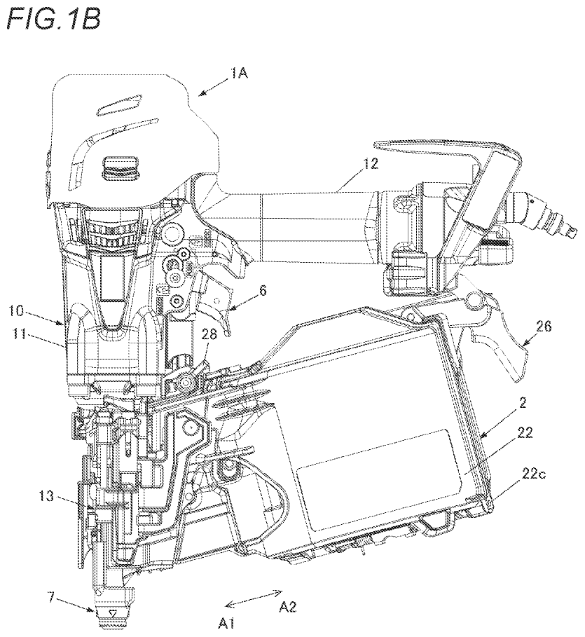

FIGS. 1A and 1B are side views illustrating an example of a nail gun according to the present embodiment, and FIG. 1A illustrates a state in which a cap portion for opening and closing a magazine is opened. FIG. 1B illustrates a state in which the cap portion is held in a closed state.

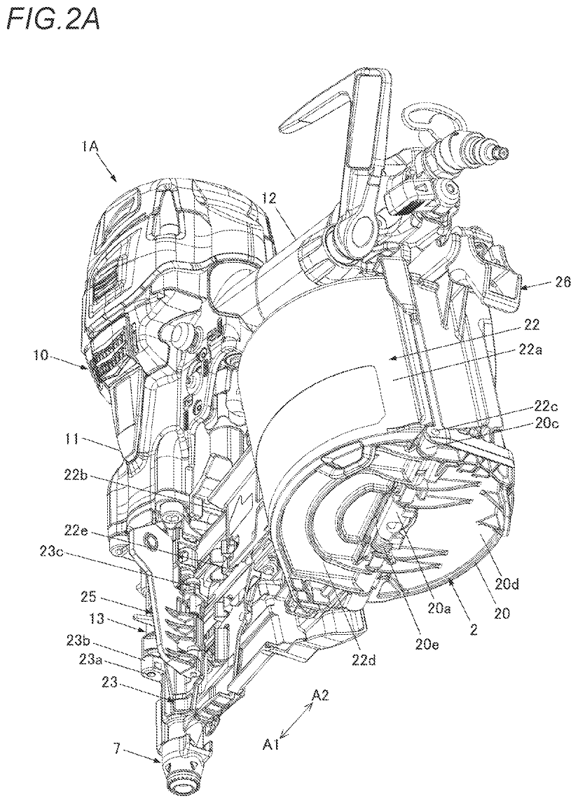

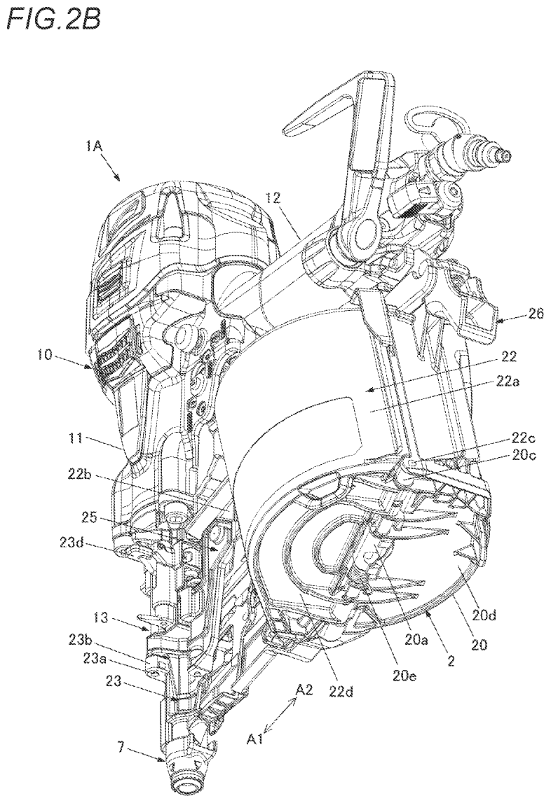

Further, FIGS. 2A and 2B are perspective views illustrating the example of the nail gun according to the present embodiment, and FIG. 2A illustrates a state in which the cap portion can be opened. FIG. 2B illustrates a state in which the cap portion is held in the closed state.

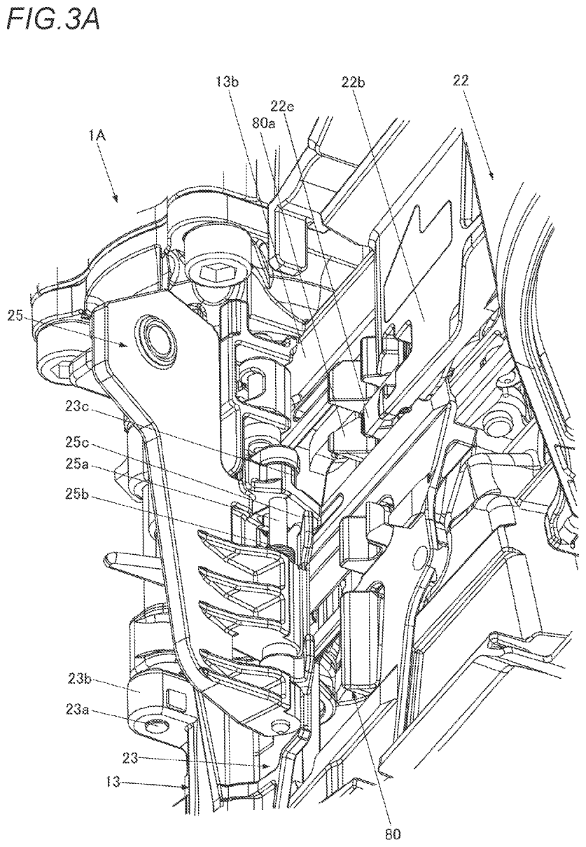

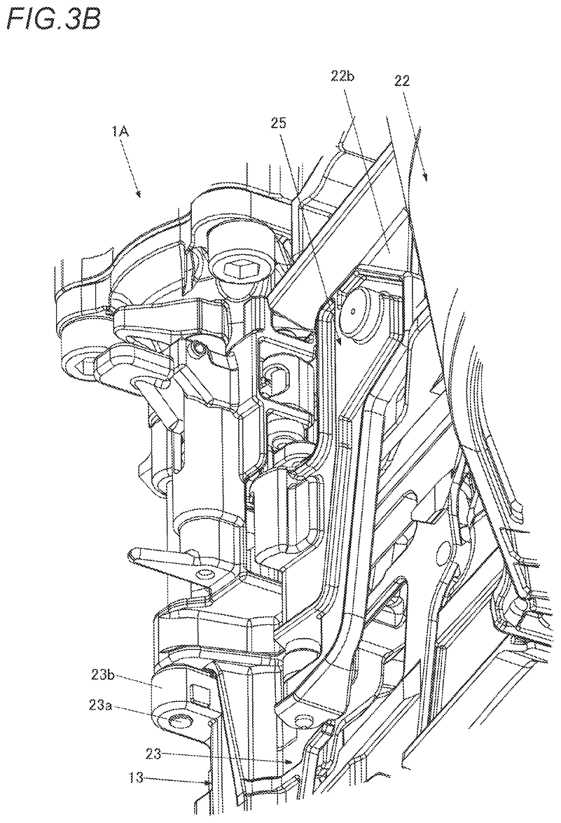

Further. FIGS. 3A and 3B are perspective views of a main part illustrating the example of the nail gun according to the present embodiment, and FIG. 3A illustrates a state in which the cap portion can be opened. FIG. 3B illustrates a state in which the cap portion is held in the closed state.

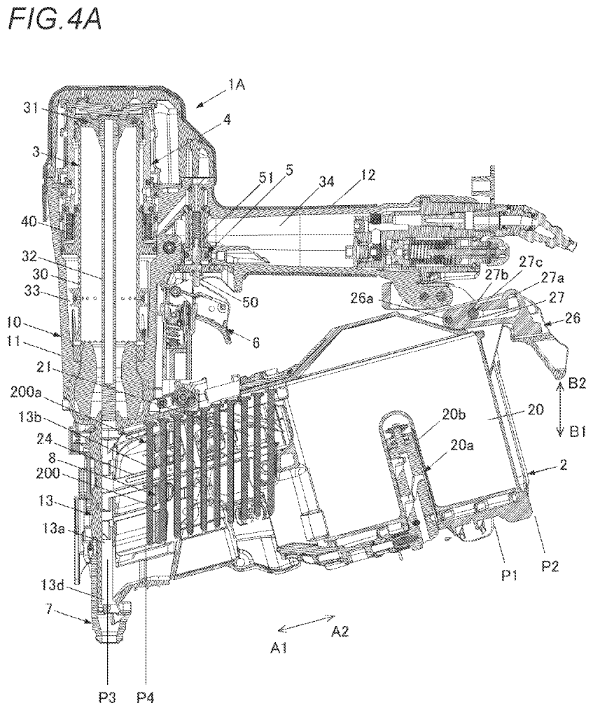

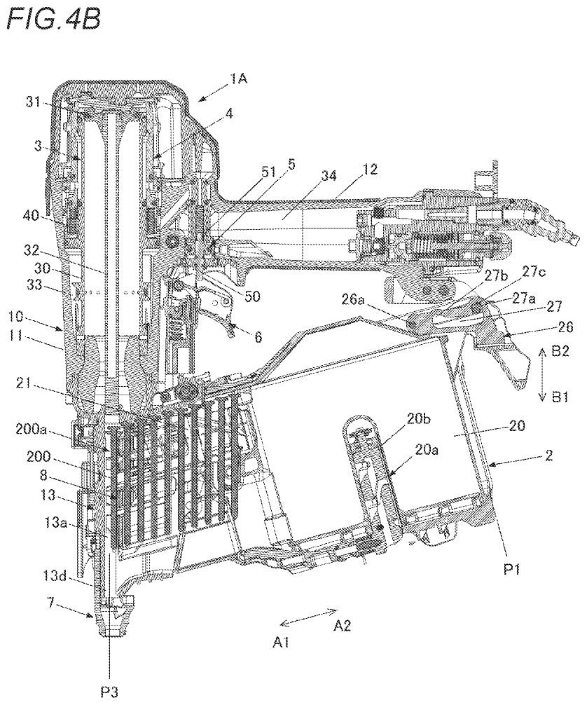

Further, FIGS. 4A and 4B are side sectional views illustrating the example of the nail gun according to the present embodiment, and FIG. 4A illustrates a state in which the cap portion can be opened. FIG. 4B illustrates a state in which the cap portion is held in the closed state.

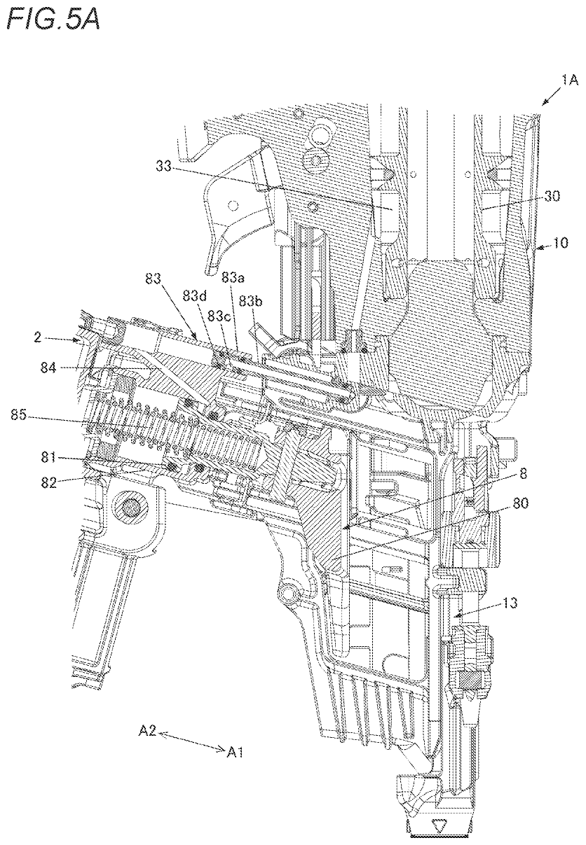

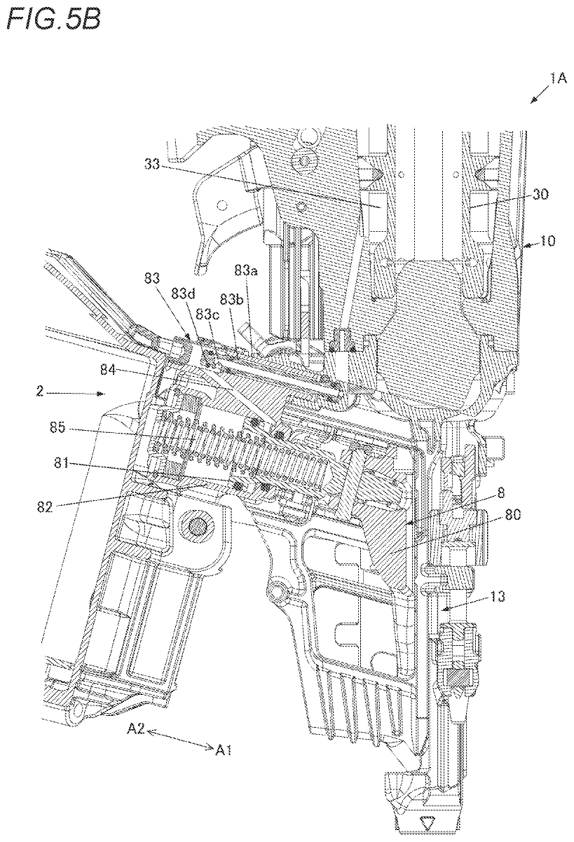

Further. FIGS. 5A and 5B are side sectional views of a main part illustrating the example of the nail gun according to the present embodiment, and FIG. 5A illustrates a state in which the cap portion can be opened. FIG. 5B illustrates a state in which the cap portion is held in the closed state.

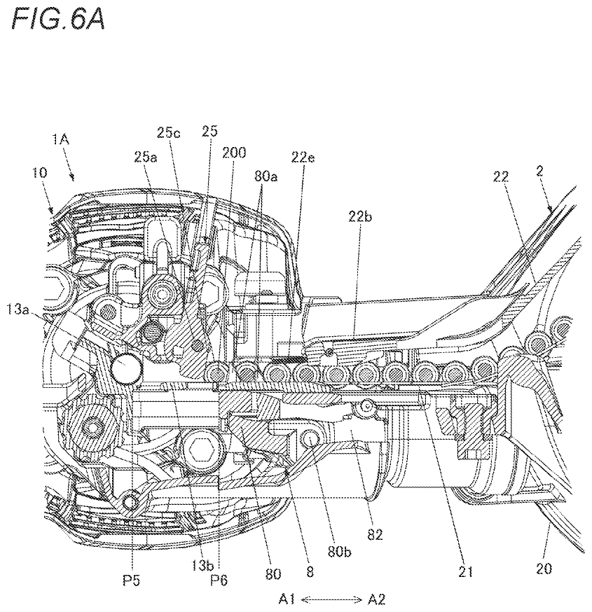

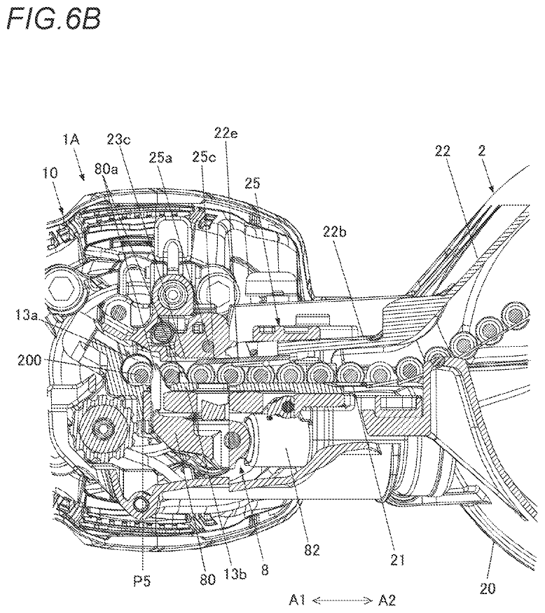

Further, FIGS. 6A and 6B are bottom sectional views of a main part illustrating the example of the nail gun according to the present embodiment, and FIG. 6A illustrates a state in which the cap portion can be opened. FIG. 6B illustrates a state in which the cap portion is held in the closed state.

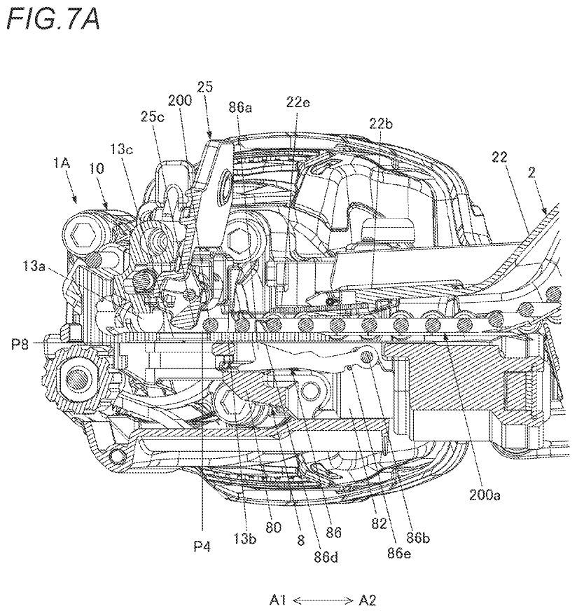

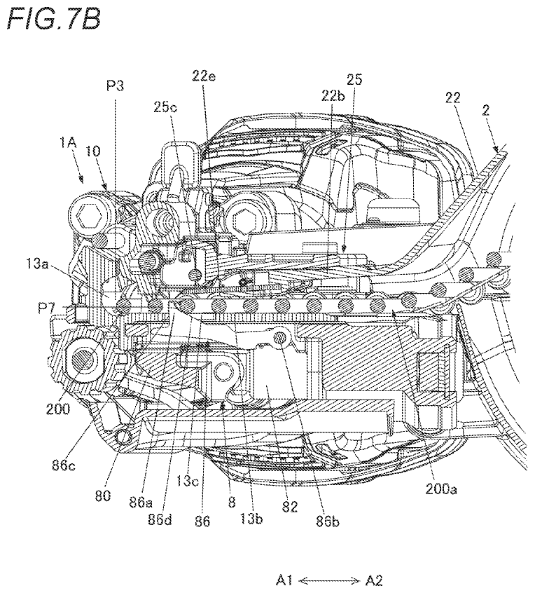

Further. FIGS. 7A and 7B are sectional perspective views of a main part illustrating an example of the nail gun according to the present embodiment, and FIG. 7A illustrates a state in which the cap portion can be opened. FIG. 7B illustrates a state in which the cap portion is held in the closed state.

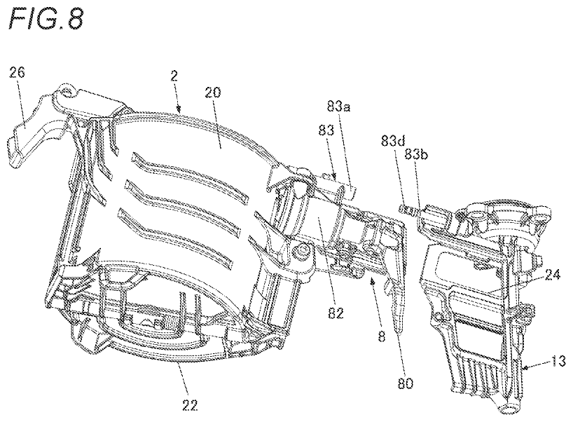

FIG. 8 is an exploded perspective view of a main part illustrating the example of the nail gun according to the present embodiment.

A nail gun 1A includes a magazine 2 that accommodates nails 200, and a main body portion 10 having a mechanism for driving out the nails 200, a mechanism for receiving an operation of driving out the nails 200, an injection passage for the nails 200, and the like. The main body portion 10 includes a trunk portion 11 provided with a striking portion 3 and the like for driving out the nails 200, and a handle portion 12 extending in a direction intersecting the trunk portion 11. The main body portion 10 includes a nose portion 13 having an injection passage 13a through which the nails 200 accommodated in the magazine 2 are supplied. The nail gun 1A includes a feeding portion 8 that feeds the nails 200 to the injection passage 13a of the nose portion 13. In the nail gun 1A, the nails 200 supplied to the injection passage 13a from the feeding portion 8 are driven out from an injection port 13d of the injection passage 13a by the striking portion 3. The nails 200 driven out by the striking portion 3 passes through the injection passage 13a.

In the nail gun 1A, one side along an extending direction of the trunk portion 11, which is a side on which the nose portion 13 is provided, is a lower side, and the other side along the extending direction of the trunk portion 11, which is a side opposite to the side on which the nose portion 13 is provided, is an upper side. The nail gun 1A is provided with the magazine 2 on a lower side of the handle portion 12.

In the nail gun 1A, a plurality of nails 200 as fasteners are connected by a connection band (not shown), and for example, connected nails 200a wound in a spiral shape are accommodated in the magazine 2.

Next, the magazine 2 and a mechanism for opening and closing the magazine 2 will be described. The magazine 2 includes an accommodation portion 20 in which a spirally wound portion of the connected nails 200a is accommodated, and a first passage portion 21 through which a portion pulled out from the spirally wound portion passes as examples of a supply portion for supplying the nails 200 to the injection passage 13a and a retraction portion for retracting the nails 200 supplied to the injection passage 13a from a portion other than the injection port 13d to the outside of the injection passage 13a.

The accommodation portion 20 is implemented by a space having a shape capable of accommodating the spirally wound portion of the connected nails 200a. The first passage portion 21 extends along a feeding direction of the nails 200 from the accommodation portion 20 toward the nose portion 13. The accommodation portion 20 and the first passage portion 21 of the magazine 2 are integrally formed.

The nose portion 13 includes a second passage portion 13b connected to the injection passage 13a. The second passage portion 13b is an example of a passage portion, and extends along the feeding direction of the nails 200 from the accommodation portion 20 toward the nose portion 13. The second passage portion 13b is connected to the injection passage 13a on a downstream side of the nails 200 in the above feeding direction, and is connected to the first passage portion 21 on an upstream side of the nails 200 in the above feeding direction. The nose portion 13 may not include the second passage portion 13b, and the first passage portion 21 of the magazine 2 may be connected to the injection passage 13a. In such a configuration, the first passage portion 21 is an example of the passage portion.

The magazine 2 includes a fastener support portion 20a that rotatably supports the spirally wound portion of the connected nails 200a. The fastener support portion 20a includes a support shaft 20b inserted into the center of the spirally wound portion of the connected nails 200a.

The magazine 2 includes the accommodation portion 20 and a cap portion 22 that opens and closes the first passage portion 21 and a part of the second passage portion 13b on a side close to the first passage portion 21. The cap portion 22 includes a first portion 22a with which the accommodation portion 20 is covered, and a second portion 22b with which the first passage portion 21 and a part of the second passage portion 13b on the side close to the first passage portion 21 are covered, which are integrally formed. The cap portion 22 opens and closes the accommodation portion 20, the first passage portion 21, and a part of the second passage portion 13b on the side close to the first passage portion 21 in a rotation operation with a shaft 22c as a fulcrum.

The shaft 22c is supported by a shaft support portion 20c provided in the accommodation portion 20 in the magazine 2. The magazine 2 includes a wall portion 20d that constitutes a part of a lower surface of the accommodation portion 20. The shaft support portion 20c is provided on the wall portion 20d. The cap portion 22 includes a wall portion 22d that constitutes a part of a lower surface of the first portion 22a The wall portion 22d of the cap portion 22 is supported by the shaft 22c. One end of the support shaft 20b of the fastener support portion 20a is supported by the shaft 22c. The fastener support portion 20a rotates from an accommodation position to a loading position with the shaft 22c as a fulcrum.

The fastener support portion 20a is biased by a biasing member 20e in an opening direction of the cap portion 22. The fastener support portion 20a rotates to the loading position with the shaft 22c as a fulcrum such that the support shaft 20b protrudes in an oblique direction from the accommodation portion 20 by the biasing of the biasing member 20e in conjunction with an operation of opening the cap portion 22. The cap portion 22 is biased in the opening direction by a force for the biasing member 20e biasing the fastener support portion 20a, and is held in an open state.

The nail gun 1A includes a door portion 23 that opens and closes the injection passage 13a and a remaining portion of the second passage portion 13b of the nose portion 13 on a side close to the injection passage 13a. The door portion 23 is formed to cover a part or the whole of a side portion of the injection passage 13a intersecting a direction in which the nails 200 is driven out and the remaining portion of the first passage portion 21 other than a portion covered with the second portion 22b of the cap portion 22, and the door portion 23 opens and closes the injection passage 13a and the remaining portion of the second passage portion 13b in a rotation operation with a shaft 23a as a fulcrum. The door portion 23 may be formed integrally with the cap portion 22, and the injection passage 13a and the remaining portion of the second passage portion 13b may be opened and closed in an operation of opening and closing the accommodation portion 20 by the cap portion 22. The door portion 23 may be fixed to the nose portion 13 and may not be opened or closed.

The shaft 23a is supported by a shaft support portion 23b provided on the nose portion 13. The shaft support portion 23b is provided in the nose portion 13 on an opposite side to the second passage portion 13b connected to the injection passage 13a. The door portion 23 includes a door operation unit 23d that receives an operation of releasing the holding of a closed state. When the door operation unit 23d is operated, the door portion 23 is released from being held in the closed state, and the injection passage 13a and the remaining portion of the second passage portion 13b can be opened and closed in the rotation operation with the shaft 23a as a fulcrum.

The nail gun 1A includes a magazine support portion 24 that movably supports the magazine 2. The magazine support portion 24 is an example of the supply portion and the retraction portion, and is provided on the nose portion 13 in this example. The magazine support portion 24 constitutes a part of the second passage portion 13b.

The magazine 2 can slide in the first direction indicated by an arrow A1 and the second direction indicated by an arrow A2 opposite to the first direction along the feeding direction of the nails 200 in the first passage portion 21 and the second passage portion 13b by the guide of the magazine support portion 24. A feeding member 80, which will be described later, of the feeding portion 8, which is an example of the supply portion and a retraction portion, is attached to the magazine 2. Further, a feed piston 81 and a feed cylinder 82 to be described later are attached to the magazine 2. In addition, a switching cylinder 83a of a switching unit 83 to be described later is attached to the magazine 2. Accordingly, when the magazine 2 is moved by the guide of the magazine support portion 24, the feeding member 80, the feed piston 81, and the feed cylinder 82 of the feeding portion 8, and the switching cylinder 83a move together with the magazine 2 in the same direction as a movement direction of the magazine 2.

The cap portion 22 is connected to the magazine 2 via the shaft 22c and moves together with the magazine 2.

The magazine 2 is moved between a closed position P1 at which the cap portion 22 is held in the closed state and an openable and closable position P2 at which the cap portion 22 is released from the closed state and can be opened and closed. The closed position P1 is a first position, and the openable and closable position P2 is a second position.

The magazine 2 is moved in the first direction indicated by the arrow A1 from the openable and closable position P2 to the closed position P1. The first direction is a direction in which the magazine 2 approaches the main body portion 10, in this example, the nose portion 13. In addition, the magazine 2 is moved in the second direction indicated by the arrow A2 from the closed position P1 to the openable and closable position P2. The second direction is a direction in which the magazine 2 is separated from the main body portion 10, in this example, the nose portion 13.

The door portion 23 includes an engaging portion 23c that is engaged with the cap portion 22 in a state in which the magazine 2 is moved to the closed position P1. The cap portion 22 includes an engaged portion 22e that is engaged with the engaging portion 23c in a state in which the magazine 2 is moved to the closed position P1. When the magazine 2 is closed in a state in which the magazine 2 is moved to the openable and closable position P2, the second portion 22b of the cap portion 22 faces the door portion 23 along the movement direction of the magazine 2. The engaged portion 22e is provided in the second portion 22b facing the door portion 23 in the cap portion 22 in which the magazine 2 is closed. The engaged portion 22e protrudes from the second portion 22b toward the door portion 23 in an arrow A1 direction along the movement direction of the magazine 2. The engaging portion 23c is provided at a portion of the door portion 23 in which the injection passage 13a and the remaining portion of the second passage portion 13b are closed, the portion facing the engaged portion 22e of the cap portion 22 in which the magazine 2 is closed. The engaging portion 23c extends along the movement direction of the magazine 2, and is provided with a recessed portion into which the engaged portion 22e can be inserted and removed.

Accordingly, the magazine 2 is moved in the first direction from the openable and closable position P2 to the closed position P1 by the guide of the magazine support portion 24, whereby the engaged portion 22e of the cap portion 22 is engaged with the engaging portion 23c of the door portion 23. In addition, the magazine 2 is moved in the second direction from the closed position P1 to the openable and closable position P2, whereby the engagement between the engaged portion 22e and the engaging portion 23c is released.

The door portion 23 includes a pressing portion 25 that presses the cap portion 22 in which the magazine 2 is closed. The pressing portion 25 has a shape so as to cover a part of the cap portion 22, and moves between a pressing position for pressing the cap portion 22 and a release position for releasing the pressing of the cap portion 22 in a rotation operation with a shaft 25a as a fulcrum.

The pressing portion 25 is biased by a biasing member 25b such as a torsion coil spring in a rotation direction from the pressing position to the release position.

The pressing portion 25 includes an acting portion 25c that is pressed against the engaged portion 22e. The acting portion 25c is provided on a movement path of the engaged portion 22e as the magazine 2 moves.

The acting portion 25c is pressed against the engaged portion 22e as the magazine 2 moves, and the pressing portion 25 rotates from the release position to the pressing position in the rotation operation with the shaft 25a as a fulcrum. The pressing portion 25 is held at the pressing position when the acting portion 25c is pressed against the engaged portion 22e. Further, when the engaged portion 22e is separated from the acting portion 25c as the magazine 2 moves, the pressing portion 25 rotates from the pressing position to the release position by the biasing of the biasing member 25b.

The nail gun 1A includes an operation unit 26 that receives an operation of moving the magazine 2. The operation unit 26 is attached to the accommodation portion 20 of the magazine 2 via a shaft 26a.

The operation unit 26 includes a holding unit 27 that holds the magazine 2 at the closed position P1 and the openable and closable position P2.

The holding unit 27 is formed in an elongated hole shape extending along the movement direction of the magazine 2, and is provided with a first engaging recessed portion 27a extending in a direction intersecting with an extending direction of the holding unit 27 at one end in the extending direction. In addition, the holding unit 27 is provided with a second engaging recessed portion 27b extending in a direction intersecting the extending direction of the holding unit 27 at the other end in the extending direction.

A shaft 27c provided on a handle portion 12 side is inserted into the holding unit 27. The shaft 27c does not move with respect to the movement of the magazine 2. On the other hand, the holding unit 27 is displaced with respect to the shaft 27c by the movement of the magazine 2 and the rotation of the operation unit 26 with the shaft 26a as a fulcrum.

When the magazine 2 is moving to the closed position P1, the first engaging recessed portion 27a of the holding unit 27 faces the shaft 27c. When the operation unit 26 rotates in a first rotation direction indicated by an arrow B1, which is one direction with the shaft 26a as a fulcrum, the first engaging recessed portion 27a of the holding unit 27 is engaged with the shaft 27c. Accordingly, the magazine 2 is held at the closed position P1.

In a state in which the holding unit 27 is moving to the closed position P1 and in a state in which the first engaging recessed portion 27a is engaged with the shaft 27c, when the operation unit 26 rotates in a second rotation direction indicated by an arrow B2, which is another direction, with the shaft 26a as a fulcrum, the engagement between the first engaging recessed portion 27a and the shaft 27c is released. Accordingly, the magazine 2 can move from the closed position P1 to the openable and closable position P2. Therefore, the magazine 2 and the cap portion 22 integrally move in the second direction by applying a force for rotating the operation unit 26 in the second rotation direction and then moving the operation unit 26 in the second direction indicated by the arrow A2 in a state in which the magazine 2 is moving to the closed position P1.

When the magazine 2 is moving to the openable and closable position P2, the second engaging recessed portion 27b of the holding unit 27 faces the shaft 27c. When the operation unit 26 rotates in the first rotation direction with the shaft 26a as a fulcrum, the second engaging recessed portion 27b of the holding unit 27 is engaged with the shaft 27c. Accordingly, the magazine 2 is held at the openable and closable position P2.

In a state in which the holding unit 27 is moving to the openable and closable position P2 and in a state in which the second engaging recessed portion 27b is engaged with the shaft 27c, when the operation unit 26 rotates in the second rotation direction indicated by the arrow B2 with the shaft 26a as a fulcrum, the engagement between the second engaging recessed portion 27b and the shaft 27c is released. Accordingly, the magazine 2 can move from the openable and closable position P2 to the closed position P1. Therefore, the magazine 2 and the cap portion 22 integrally move in the first direction by applying a force for rotating the operation unit 26 in the second rotation direction and then moving the operation unit 26 in the first direction indicated by the arrow A1 in a state in which the magazine 2 is moving to the openable and closable position P2.

The nail gun 1A includes a sub-operation unit 28 that restricts the opening of the cap portion 22 in a state in which the magazine 2 is moved to the openable and closable position P2. The sub-operation unit 28 can press the cap portion 22 in which the accommodation portion 20 is closed in the state in which the magazine 2 is moved to the openable and closable position P2. The sub-operation unit 28 may press the cap portion 22 in which the accommodation portion 20 is closed in the state in which the magazine 2 is moved to the closed position P1, and may move integrally with the magazine 2 while maintaining the state in which the sub-operation unit 28 presses the cap portion 22 in an operation of moving the magazine 2 from the closed position P1 to the openable and closable position P2.

Next, the mechanism for driving out the nail 200, the mechanism for receiving an operation for driving out the nails 200, a mechanism for feeding the nails 200, and the like will be described. The nail gun 1A includes a main valve 4 that switches whether to supply compressed air to the striking portion 3, a starting valve 5 that causes the main valve 4 to operate, and a trigger 6 that switches between a sign-in state in which the starting valve 5 is operable and a sign-off state in which the starting valve 5 is not operable. In addition, the nail gun 1A includes a contact portion 7 that comes into contact with a material to be driven (not shown) and switches between the sign-in state in which the starting valve 5 is operable and the sign-off state in which the starting valve 5 is not operable. Further, the nail gun 1A includes the feeding portion 8 that feeds the nails 200 to the injection passage 13a of the nose portion 13. The nail gun 1A is brought into the sign-in state in which the starting valve 5 is operable by an operation of pulling the trigger 6. From the sign-in state, the starting valve 5 is operated by an operation of pressing the contact portion 7 against the material to be driven (not shown). In addition, the nail gun 1A is brought into the sign-in state in which the starting valve 5 is operable by the operation of pressing the contact portion 7 against the material to be driven (not shown). From the sign-in state, the starting valve 5 is operated by the operation of pulling the trigger 6.

The striking portion 3 is an example of a driving portion, and includes a striking cylinder 30 to which compressed air is supplied. The striking cylinder 30 is provided inside the trunk portion 11 so as to extend vertically. The striking cylinder 30 is slidably provided with a striking piston 31 in a cylindrical internal space. The striking portion 3 protrudes below the striking piston 31, and a driver 32 is attached to the striking piston 31.

The nail gun 1A includes a blowback chamber 33 connected to the striking cylinder 30. The nail gun 1A supplies the compressed air from the striking cylinder 30 to the blowback chamber 33 in an operation of moving the striking piston 31 from a top dead center position to a bottom dead center position. When the nail gun 1A is brought into the sign-off state and the air on the striking piston 31 of the striking cylinder 30 is discharged, the compressed air in the blowback chamber 33 is discharged via the striking cylinder 30, whereby the striking piston 31 returns to the top dead center position by an air pressure of the compressed air supplied from the blowback chamber 33 to below the striking piston 31 of the striking cylinder 30. In addition, the nail gun 1A causes the feeding portion 8 to operate by an air pressure of the compressed air supplied from the blowback chamber 33 to the feeding portion 8.

The main valve 4 opens and closes an air flow path connecting the striking cylinder 30 and a main chamber 34 to which compressed air is supplied from an external air compressor (not shown). In the starting valve 5, a pilot valve 51 is operated when a valve stem 50 is pressed in a combination of the operation of the trigger 6 and the operation of pressing the contact portion 7 against the material to be driven. The starting valve 5 changes an air pressure applied to the main valve 4 by operating the pilot valve 51. The main valve 4 is operated by the balance between a biasing force of a main valve spring 40 and the air pressure applied to the main valve 4.

The feeding portion 8 includes the feeding member 80 that feeds the connected nails 200a, the feed piston 81 connected to the feeding member 80, and the feed cylinder 82 that causes the feed piston 81 to operate as examples of the supply portion and the retraction portion. In addition, the feeding portion 8 includes the switching unit 83 that switches whether to supply the compressed air from the blowback chamber 33 to the feed cylinder 82.

The feeding member 80 includes a claw portion 80a protruding to the second passage portion 13b. The claw portion 80a of the feeding member 80 is engaged with the nail 200. The feeding member 80 is supported movably with respect to the second passage portion 13b. The feeding member 80 can move in a direction in which the claw portion 80a approaches the injection passage 13a of the nose portion 13 and a direction in which the claw portion 80a is separated from the injection passage 13a of the nose portion 13. In addition, the feeding member 80 can move in a direction in which the claw portion 80a protrudes from the second passage portion 13b and a direction in which the claw portion 80a retreats from the second passage portion 13b in a rotation operation with a shaft 80b as a fulcrum. The claw portion 80a of the feeding member 80 is located in the second direction from the door portion 23 in a state in which the magazine 2 is moved to the openable and closable position P2 at which the cap portion 22 can be opened and closed. Accordingly, when the cap portion 22 is opened, the claw portion 80a is exposed to the second passage portion 13b even in a state in which the door portion 23 is closed, and the connected nails 200a can be loaded. In a state in which the leading nail 200 of the connected nails 200a is located in the injection passage 13a, the claw portion 80a of the feeding member 80 is engaged with the second nail 200 of the connected nails 200a.

The feed piston 81 is slidably supported in the feed cylinder 82. The feed cylinder 82 is connected to the blowback chamber 33 via a feed flow path 84 and the switching unit 83, and is supplied with the compressed air from the blowback chamber 33.

The feed piston 81 is operated by the air pressure of the compressed air supplied from the blowback chamber 33 to cause the feeding member 80 to move in the direction separated from the injection passage 13a. The feed piston 81 is biased by a biasing member 85 such as a coil spring in a direction in which the feeding member 80 approaches the injection passage 13a. When an air pressure in the feed cylinder 82 decreases as a result of the air in the feed cylinder 82 flowing into the blowback chamber 33 and being discharged via the striking cylinder 30, the feed piston 81 moves the feeding member 80 in a direction approaching the injection passage 13a by the biasing force of the biasing member 85.

The switching unit 83 includes the switching cylinder 83a connected to the feed flow path 84 and a switching valve 83b that opens and closes the feed flow path 84. The switching valve 83b of the switching unit 83 is slidably supported in the switching cylinder 83a. The switching unit 83 switches whether an outflow port 83c formed in the switching valve 83b is connected to the feed flow path 84 or a sealing member 83d provided in the switching valve 83b seals a space between the outflow port 83c and the feed flow path 84 by a relative movement of the switching cylinder 83a and the switching valve 83b.

The feeding member 80 is attached to the magazine 2. In addition, the feed piston 81 and the feed cylinder 82 are attached to the magazine 2. Further, the switching cylinder 83a of the switching unit 83 is attached to the magazine 2. Accordingly, when the magazine 2 is moved in the first direction by the guide of the magazine support portion 24, the feeding member 80, the feed piston 81, and the feed cylinder 82 of the feeding portion 8, and the switching cylinder 83a move in the first direction together with the magazine 2. In addition, when the magazine 2 is moved in the second direction by the guide of the magazine support portion 24, the feeding member 80, the feed piston 81, the feed cylinder 82, and the switching cylinder 83a move in the second direction together with the magazine 2.

The switching valve 83b of the switching unit 83 is attached to the nose portion 13. Accordingly, in an operation of moving the magazine 2, a relative position of the switching valve 83b with respect to the switching cylinder 83a changes, whereby the presence or absence of the communication between the outflow port 83c and the feed flow path 84 is switched, and the presence or absence of supply of the compressed air from the blowback chamber 33 to the feed cylinder 82 is switched.

The feeding member 80 moves from a feeding operation position P5 to a retracted position P6 by moving together with the magazine 2 in an operation of moving the magazine 2 from the closed position P1 to the openable and closable position P2. When the feeding member 80 moves to the feeding operation position P5 with the connected nails 200a engaged therewith, the feeding member 80 moves the connected nails 200a to an injection enable position P3. In addition, when the feeding member 80 moves to the retracted position P6 with the connected nails 200a engaged therewith, the feeding member 80 moves the connected nails 200a to a removable position P4.

Accordingly, in the nail gun 1A, the connected nails 200a are moved from the injection enable position P3 to the removable position P4 in the operation of moving the magazine 2 from the closed position P1 to the openable and closable position P2. When the connected nails 200a are moving to the injection enable position P3, the leading nail 200 is located in the injection passage 13a. In addition, when the connected nails 200a are moved to the removable position P4, the leading nail 200 retracts from the portion other than the injection port 13d to the outside of the injection passage 13a. Further, when the connected nails 200a are moved to the removable position P4, the cap portion 22 is opened in a state in which the magazine 2 is moved to the openable and closable position P2, whereby the connected nails 200a are exposed to the first passage portion 21 and the second passage portion 13b.

When the magazine 2 is moving to the closed position P1, the feed piston 81 is biased by the biasing member 85, whereby the feeding member 80 is moved to the feeding operation position P5. When the feeding member 80 is moved to the feeding operation position P5, the leading nail 200 of the connected nails 200a engaged with the feeding member 80 is moved to the injection enable position P3.

In the nail gun 1A, when the magazine 2 is moving to the closed position P1, after the feeding member 80 is moved from the feeding operation position P5 in the second direction by a predetermined amount by the compressed air being supplied to the feed cylinder 82 in conjunction with an operation of driving the nails 200 by the striking portion 3, the feeding member 80 is moved in the first direction by the decrease in the air pressure in the feed cylinder 82 and the biasing of the biasing member 85 and returns to the feeding operation position P5.

Accordingly, the feeding operation position P5 is a position at which normal nail feeding for moving the nails 200 to the injection enable position P3 is enabled by a reciprocating movement of the feeding member 80 by supplying the compressed air in conjunction with the operation of driving the nails 200 by the striking portion 3.

When the magazine 2 is moved from the closed position P1 to the openable and closable position P2, the feeding member 80 is moved from the feeding operation position P5 to the retracted position P6. When the feeding member 80 is moved to the retracted position P6, the leading nail 200 of the connected nails 200a engaged with the feeding member 80 is moved from the injection enable position P3 to the removable position P4. The removable position P4 is a position at which the nails 200 are separated by a predetermined amount in the second direction from a movement path of the driver 32 passing through the injection passage 13a.

Accordingly, the retracted position P6 is a position at which the connected nails 200a can be removed from the first passage portion 21 and the second passage portion 13b. In addition, the retracted position P6 is a position at which the leading nail 200 of the connected nails 200a is not driven even when the driver 32 moves. Therefore, the removable position P4 is also referred to as an injection avoidance position at which the nails 200 are prevented from being driven out.

When the magazine 2 is moving to the closed position P1, the outflow port 83c and the feed flow path 84 are connected to each other by a change in the relative position of the switching valve 83b with respect to the switching cylinder 83a, and the compressed air can be supplied from the blowback chamber 33 to the feed cylinder 82. On the other hand, when the magazine 2 is moved from the closed position P1 to the openable and closable position P2, the space between the outflow port 83c and the feed flow path 84 is sealed, and the supply of the compressed air from the blowback chamber 33 to the feed cylinder 82 is blocked.

Accordingly, in a state in which the magazine 2 is moved to the openable and closable position P2, even when the operation of driving the nails 200 by the striking portion 3 is performed, the feeding member 80 does not reciprocate in a state of being moved to the retracted position P6. On the other hand, the feeding member 80 moved to the retracted position P6 may reciprocate as long as the leading nail 200 of the connected nails 200a engaged with the feeding member 80 does not move to the injection enable position P3. In this case, even when the magazine 2 is moved from the closed position P1 to the openable and closable position P2, the compressed air may be supplied from the blowback chamber 33 to the feed cylinder 82.

The feeding member 80 is moved between the feeding operation position P5 and the retracted position P6 by moving in the first direction and the second direction similarly to the magazine 2, and may move in a direction different from that of the magazine 2. For example, in order to move the feeding member 80 from the feeding operation position P5 to the retracted position P6, the magazine 2 and the feed cylinder 82 may be moved in an oblique direction gradually separated from the second direction, and the feeding member 80 may be moved in the second direction.

As described above, in the nail gun 1A, when the feeding member 80 is moved from the feeding operation position P5 in the second direction by the predetermined amount in the state in which the magazine 2 is moving to the closed position P1, the connected nails 200a are restricted from moving in a direction separated from the injection passage 13a.

Therefore, the feeding portion 8 includes a restriction portion 86 that switches whether the connected nails 200a are restricted from moving from the injection enable position P3 illustrated in FIG. 7B to the removable position P4 illustrated in FIG. 7A.

The restriction portion 86 includes a claw portion 86a that is engaged with the nail 200. The restriction portion 86 is biased by a biasing member (not shown) in a direction in which the claw portion 86a protrudes from a hole portion 13c of the second passage portion 13b in a rotation operation with a shaft 86b as a fulcrum.

The restriction portion 86 has a restriction surface 86c implemented by a surface substantially perpendicular to the feeding direction of the connected nails 200a on a side facing the injection passage 13a on the claw portion 86a. In addition, the restriction portion 86 has an inclined surface 86d implemented by a surface inclined in a direction in which an amount of protrusion from the hole portion 13c decreases toward the accommodation portion 20 with respect to the feeding direction of the connected nails 200a on a side facing the accommodation portion 20 on the claw portion 86a.

When the magazine 2 is moving to the closed position P1 as illustrated in FIG. 4B, the claw portion 86a of the restriction portion 86 faces the hole portion 13c of the second passage portion 13b as illustrated in FIG. 7B. Accordingly, the restriction portion 86 is biased by a biasing member 86e, so that the restriction portion 86 moves to a movement restriction position P7 at which the claw portion 86a protrudes from the hole portion 13c to a surface side of the second passage portion 13b in the rotation operation with the shaft 86b as a fulcrum.

The restriction portion 86 is attached to the magazine 2. In this example, the restriction portion 86 can move integrally with the magazine 2 by the shaft 86b being supported by the feed cylinder 82. As illustrated in FIG. 4A, in the restriction portion 86, when the magazine 2 is moved from the closed position P1 to the openable and closable position P2, the inclined surface 86d of the claw portion 86a is pressed against an opening edge of the hole portion 13c. Accordingly, as illustrated in FIG. 7A, the restriction portion 86 moves to a restriction release position P8 at which the restriction portion 86 retracts to a back side of the second passage portion 13b in the rotation operation with the shaft 86b as a fulcrum.

### <Example of Operation of Opening and Closing Magazine>

Next, an example of the operation of opening and closing the cap portion 22 will be described.

When the magazine 2 is moving to the closed position P1, the cap portion 22 closes the accommodation portion 20, and the cap portion 22 is held in a state in which the accommodation portion 20 is closed. That is, in the magazine 2, the engaged portion 22e of the cap portion 22 is engaged with the engaging portion 23c of the door portion 23.

When the magazine 2 is moving to the closed position P1, the first engaging recessed portion 27a of the holding unit 27 of the operation unit 26 faces the shaft 27c. When the operation unit 26 rotates in the first rotation direction with the shaft 26a as a fulcrum, the first engaging recessed portion 27a of the holding unit 27 is engaged with the shaft 27c.

When the magazine 2 is moving to the closed position P1, the acting portion 25c is pressed against the engaged portion 22e, and the pressing portion 25 rotates from the release position to the pressing position in the rotation operation with the shaft 25a as a fulcrum and is held at the pressing position. Accordingly, the magazine 2 is held at the closed position P1.

When the magazine 2 is moving to the closed position P1, the outflow port 83c is connected to the feed flow path 84 by the relative movement of the switching cylinder 83a and the switching valve 83b of the switching unit 83 of the feeding portion 8.

In order to open the cap portion 22, the magazine 2 is moved in the second direction. Therefore, first, the operation unit 26 is moved in a direction in which the magazine 2 is moved in the second direction. When the operation unit 26 receives a force for moving the magazine 2 in the second direction, the operation unit 26 rotates in the second rotation direction with the shaft 26a as a fulcrum. When the operation unit 26 rotates in the second rotation direction, the engagement between the first engaging recessed portion 27a and the shaft 27c is released. Accordingly, the magazine 2 can move from the closed position P1 to the openable and closable position P2.

In the magazine 2, the accommodation portion 20 and the cap portion 22 integrally move in the second direction by an operation of further moving the operation unit 26 in the second direction. When the magazine 2 is moved from the closed position P1 to the openable and closable position P2, the engaged portion 22e is disengaged from the engaging portion 23c, and the engagement between the engaged portion 22e and the engaging portion 23c is released. In this way, by moving the operation unit 26 in the direction in which the magazine 2 is moved in the second direction, the operation of releasing the engagement between the first engaging recessed portion 27a and the shaft 27c and the operation of moving the magazine 2 from the closed position P1 to the openable and closable position P2 can be performed simultaneously.

When the magazine 2 is moved from the closed position P1 to the openable and closable position P2, the engaged portion 22e is separated from the acting portion 25c, and the pressing portion 25 rotates from the pressing position to the release position by the biasing of the biasing member 25b.

Accordingly, the cap portion 22 can be opened toward the accommodation portion 20. In a state in which the nails 200 are not accommodated in the magazine 2, the fastener support portion 20a is biased by the biasing member 20e in the opening direction of the cap portion 22, whereby the cap portion 22 is opened in conjunction with the fastener support portion 20a.

When the magazine 2 is moved from the closed position P1 to the openable and closable position P2, the first passage portion 21 is separated from the second passage portion 13b. Further, when the magazine 2 is moved from the closed position P1 to the openable and closable position P2, the feeding member 80 of the feeding portion 8 moves in the second direction in conjunction with the magazine 2. When the magazine 2 is moved from the closed position P1 to the openable and closable position P2, the restriction portion 86 moves to the restriction release position P8 at which the claw portion 86a retracts to the back side of the second passage portion 13b. Accordingly, when the magazine 2 is moved to the openable and closable position P2 in a state in which the nails 200 are accommodated in the magazine 2, the nail 200 is engaged with the claw portion 80a, whereby the connected nails 200a are moved in the second direction, and the leading nail 200 is moved from the injection passage 13a to a first passage portion 21 side and retreats from the injection passage 13a.

When the magazine 2 is moved to the openable and closable position P2, the feeding portion 8 seals the space between the outflow port 83c and the feed flow path 84 with the sealing member 83d by the relative movement of the switching cylinder 83a and the switching valve 83b of the switching unit 83. Accordingly, in the state in which the magazine 2 is moving to the openable and closable position P2, even when the nail gun 1A is operated, the compressed air is not supplied to the feeding portion 8, and the feeding portion 8 does not operate.

When the magazine 2 is moved to the openable and closable position P2 and the force for moving the magazine 2 in the second direction is not applied to the operation unit 26 in the state in which the second engaging recessed portion 27b faces the shaft 27c, the operation unit 26 rotates in the first rotation direction with the shaft 26a as a fulcrum. When operation unit 26 rotates in the first rotation direction, the second engaging recessed portion 27b is engaged with the shaft 27c. Accordingly, the magazine 2 is held at the openable and closable position P2.

In order to load the nails 200 into the magazine 2, the spirally wound portion of the connected nails 200a is inserted into the support shaft 20b of the fastener support portion 20a. The fastener support portion 20a rotates to the accommodation position due to a weight of the connected nails 200a as the connected nails 200a are loaded.

When the nails 200 are loaded into the magazine 2, a portion pulled out from the spirally wound portion of the connected nails 200a is loaded into the first passage portion 21 and the second passage portion 13b. In a state in which the cap portion 22 is opened, the claw portion 80a of the feeding member 80 is exposed to the second passage portion 13b. Accordingly, the nail 200 is engaged with the claw portion 80a in the operation of loading the portion pulled out from the spirally wound portion of the connected nails 200a into the first passage portion 21 and the second passage portion 13b. The leading nail 200 does not need to be loaded into the injection passage 13a of the nose portion 13 in an operation of loading the connected nails 200a into the first passage portion 21 and the second passage portion 13b.

After the nails 200 are loaded into the magazine 2, the cap portion 22 is closed. In the state in which the magazine 2 is moving to the openable and closable position P2, the cap portion 22 is not held in a closed state even when the cap portion 22 is closed.

After the cap portion 22 is closed, the magazine 2 is moved in the first direction. Therefore, first, the operation unit 26 rotates in the second rotation direction with the shaft 26a as a fulcrum. When the operation unit 26 rotates in the second rotation direction, the engagement between the second engaging recessed portion 27b and the shaft 27c is released. Accordingly, the magazine 2 can move from the openable and closable position P2 to the closed position P1 by moving the operation unit 26 in a direction of moving in the first direction. When a force for directly pressing the magazine 2 to cause the magazine 2 to move in the first direction is applied after the cap portion 22 is closed, the engagement between the second engaging recessed portion 27b and the shaft 27c is held until a predetermined load is applied. When the magazine 2 is directly pressed and the predetermined load is applied, the operation unit 26 rotates in the second rotation direction with the shaft 26a as a fulcrum, and the engagement between the second engaging recessed portion 27b and the shaft 27c is released. Accordingly, the magazine 2 can also be moved from the openable and closable position P2 to the closed position P1 by directly pressing the magazine 2 in the direction of moving in the first direction.

The accommodation portion 20 and the cap portion 22 of the magazine 2 integrally move in the first direction in an operation of further moving the operation unit 26 in the first direction. When the magazine 2 is moved from the openable and closable position P2 to the closed position P1 in the state in which the cap portion 22 is closed, the engaged portion 22e presses the acting portion 25c of the pressing portion 25. When the acting portion 25c is pressed against the engaged portion 22e, the pressing portion 25 rotates from the release position to the pressing position in the rotation operation with the shaft 25a as a fulcrum. The pressing portion 25 is held at the pressing position when the acting portion 25c is pressed against the engaged portion 22e.

When the magazine 2 is moved from the openable and closable position P2 to the closed position P1 in the state in which the cap portion 22 is closed, the engaged portion 22e is engaged with the engaging portion 23c. Accordingly, the magazine 2 is moved to the closed position P1, whereby the cap portion 22 is held in the state in which the accommodation portion 20 is closed. In addition, the cap portion 22 in the closed state is pressed by the pressing portion 25.

When the magazine 2 is moved from the openable and closable position P2 to the closed position P1, the first passage portion 21 and the second passage portion 13b are connected to each other. In addition, when the magazine 2 is moved from the openable and closable position P2 to the closed position P1, the feeding member 80 of the feeding portion 8 is moved in the first direction in conjunction with the magazine 2. Accordingly, when the magazine 2 is moved to the closed position P1 in the state in which the nails 200 are accommodated in the magazine 2, the nail 200 is engaged with the claw portion 80a, whereby the nails 200 are moved in the first direction, and the leading nail 200 is moved to the injection passage 13a.

When the magazine 2 is moved from the openable and closable position P2 to the closed position P1, the restriction portion 86 moves to the movement restriction position P7 at which the claw portion 86a protrudes from the hole portion 13c to the surface side of the second passage portion 13b. Accordingly, the restriction portion 86 restricts the connected nails 200a moving in the direction separated from the injection passage 13a.

When the magazine 2 is moved to the closed position P1, the outflow port 83c is connected to the feed flow path 84 by the relative movement of the switching cylinder 83a and the switching valve 83b of the switching unit 83 of the feeding portion 8. Accordingly, in the state in which the magazine 2 is moving to the closed position P1, when the nail gun 1A is operated, the compressed air is supplied to the feeding portion 8 at a predetermined timing, and the feeding portion 8 is operated.

When the magazine 2 is moved to the closed position P1 and the force for moving the magazine 2 in the first direction is not applied to the operation unit 26 in the state in which the first engaging recessed portion 27a faces the shaft 27c, the operation unit 26 rotates in the first rotation direction with the shaft 26a as a fulcrum. When operation unit 26 rotates in the first rotation direction, the first engaging recessed portion 27a is engaged with the shaft 27c. Accordingly, the magazine 2 is held at the closed position P1.

The nail gun 1A can also be operated to open the cap portion 22 by releasing the holding of the door portion 23 in the closed state and opening the door portion 23 in the operation of the door operation unit 23d, similarly to the configuration in the related art. That is, when the door portion 23 is opened, the engaging portion 23c is disengaged from a position at which the engaging portion 23c is engaged with the engaged portion 22e, and the pressing portion 25 is disengaged from a position at which the cap portion 22 is pressed. Accordingly, when the door portion 23 is opened, the cap portion 22 is opened, and the claw portion 80a of the feeding member 80 is exposed.

When the connected nails 200a used halfway are taken out for replacement or the like, as described above, the magazine 2 is moved from the closed position P1 to the openable and closable position P2, and the cap portion 22 is opened.

In the nail gun 1A, when the magazine 2 is moved to the openable and closable position P2 in a state in which the connected nails 200a are moving to the injection enable position P3, the connected nails 200a are moved to the removable position P4. When the connected nails 200a are moved to the removable position P4, the leading nail 200 of the connected nails 200a is moved from the injection passage 13a to the first passage portion 21 side and retreats from the injection passage 13a. In addition, the connected nails 200a are exposed to the first passage portion 21 and the second passage portion 13b.

Accordingly, the portion pulled out from the spirally wound portion of the connected nails 200a is taken out from the first passage portion 21 and the second passage portion 13b, and the spirally wound portion of the connected nails 200a can be removed from the fastener support portion 20a and taken out from the accommodation portion 20.

### <Example of Nail Driving Operation of Nail Gun of Present Embodiment>

Next, the operation of driving the nails 200 by the nail gun 1A will be described. As described above, when the nails 200 are loaded into the magazine 2 in the operation of moving the magazine 2 from the openable and closable position P2 to the closed position P1, the leading nail 200 is located in the injection passage 13a.

When the nails 200 are to be driven by the nail gun 1A, an operator presses the contact portion 7 against the material to be driven (not shown) and operates the trigger 6.

The valve stem 50 of the starting valve 5 is pressed in the combination of the operation of the trigger 6 and the operation of pressing the contact portion 7 against the material to be driven. In the starting valve 5, when the valve stem 50 is moved from a standby position, the balance of an air pressure of compressed air applied to the pilot valve 51 changes, whereby the pilot valve 51 is operated and is moved from the standby position.

when the pilot valve 51 is moved from the standby position, the balance between an air pressure of compressed air applied to the main valve 4 and the biasing force of the main valve spring 40 changes, whereby the main valve 4 is opened.

When the main valve 4 is opened, the striking portion 3 supplies the compressed air to the striking cylinder 30. When the striking portion 3 supplies the compressed air to the striking cylinder 30, the striking piston 31 to which the driver 32 is attached is pressed by the air pressure, and moves downward from the top dead center position to the bottom dead center position. As the striking piston 31 moves from the top dead center position to the bottom dead center position, the striking portion 3 drives the nails 200 positioned in the injection passage 13a into the material to be driven by the driver 32.

When the striking piston 31 moves downward from the top dead center position in the operation of driving the nails 200, the blowback chamber 33 is supplied with the air on an upper side of the striking piston 31, and a pressure in the blowback chamber 33 increases.

In the striking portion 3, when the pressure in the blowback chamber 33 increases, the compressed air in the blowback chamber 33 is supplied from the feed flow path 84 to the feed cylinder 82. Accordingly, in the feeding portion 8, the feeding member 80 connected to the feed piston 81 is moved in the second direction separated from the injection passage 13a.

When the magazine 2 is moving to the closed position P1, the restriction portion 86 is moved to the movement restriction position P7 at which the claw portion 86a protrudes from the hole portion 13c to the surface side of the second passage portion 13b as illustrated in FIG. 7B. When the feeding member 80 is moved in the direction separated from the injection passage 13a, the nail 200 comes into contact with the restriction surface 86c of the claw portion 86a of the restriction portion 86. Accordingly, the restriction portion 86 restricts the connected nails 200a moving in the direction separated from the injection passage 13a.

When the feeding member 80 of the feeding portion 8 moves in the direction separated from the injection passage 13a in the state in which the restriction portion 86 restricts the connected nails 200a from moving in the direction separated from the injection passage 13a, the claw portion 80a is pressed against the nail 200 and retracts from the second passage portion 13b in the rotation operation with a shaft 80b as a fulcrum. When the feeding member 80 of the feeding portion 8 moves to a position at which the claw portion 80a passes through the leading nail 200, the claw portion 80a protrudes to the second passage portion 13b and is engaged with the next nail 200.

When the driving of the nails 200 ends, the operator moves the nail gun 1A in a direction separated from the material to be driven. Further, the operation of the trigger 6 ends.

When the contact portion 7 is separated from the material to be driven and returns to the standby position by moving the nail gun 1A in the direction separated from the material to be driven or when the operation of the trigger 6 ends, the valve stem 50 of the starting valve 5 returns to the standby position. In the starting valve 5, when the valve stem 50 returns to the standby position, the balance of the air pressure of the compressed air applied to the pilot valve 51 changes, whereby the pilot valve 51 returns to the standby position, when the pilot valve 51 returns to the standby position, the balance between the air pressure of the compressed air applied to the main valve 4 and the biasing force of the main valve spring 40 changes, whereby the main valve 4 is opened.

In the striking portion 3, when the main valve 4 is closed, the supply of the compressed air to the striking cylinder 30 is stopped, and the air in the striking cylinder 30 is discharged, whereby a pressure in the striking cylinder 30 decreases. In the striking portion 3, when the pressure in the striking cylinder 30 decreases, the compressed air in the blowback chamber 33 is supplied to a space below the striking piston 31, and the striking piston 31 moves to the top dead center position.

In the blowback chamber 33, when the compressed air is supplied from the blowback chamber 33 to the striking cylinder 30, the pressure in the blowback chamber 33 decreases.

When the compressed air in the blowback chamber 33 is supplied to the striking cylinder 30 and the pressure in the blowback chamber 33 decreases, in the feeding portion 8, the air in the feed cylinder 82 flows into the blowback chamber 33 and is discharged via the striking cylinder 30, whereby the air pressure in the feed cylinder 82 decreases. In the feeding portion 8, when the air pressure in the feed cylinder 82 decreases, an air pressure applied to the feed piston 81 decreases, and the feeding member 80 connected to the feed piston 81 moves in the direction approaching the injection passage 13a by the biasing of the biasing member 85. When the feeding member 80 moves in the direction approaching the injection passage 13a, the feeding portion 8 feeds the next nail 200 engaged with the claw portion 80a to the injection passage 13a.

In an operation of feeding the next nail 200 to the injection passage 13a, the further next nail 200 of the connected nails 200a comes into contact with the inclined surface 86d of the claw portion 86a of the restriction portion 86. Accordingly, the inclined surface 86d of the claw portion 86a is pressed against the nail 200, and the restriction portion 86 retracts from the second passage portion 13b. The restriction portion 86 restricts that when the leading nail 200 of the connected nails 200a is fed to the injection passage 13a and the nail 200 passes through the claw portion 86a, the claw portion 86a protrudes to the second passage portion 13b, and the connected nails 200a move in the direction separated from the injection passage 13a. Accordingly, the next nail 200 can be driven.

### <Modification of Nail Gun of Present Embodiment>

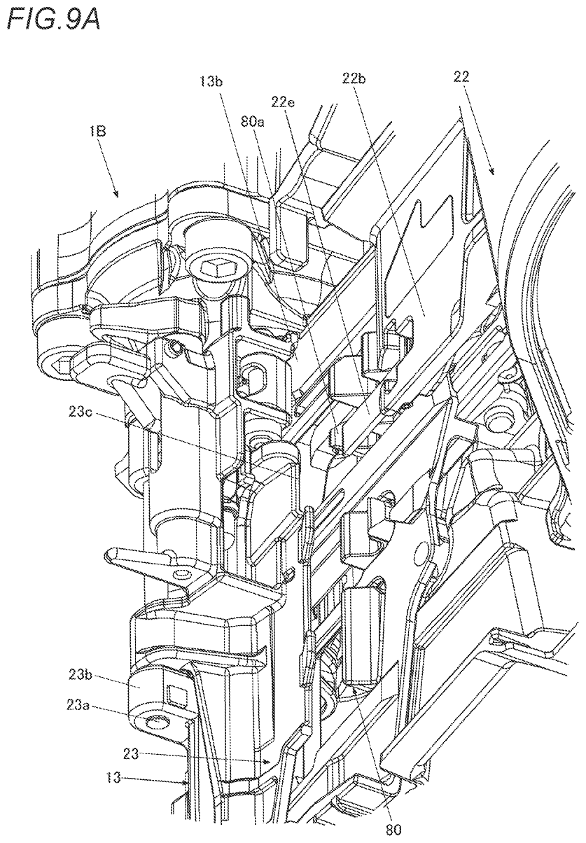

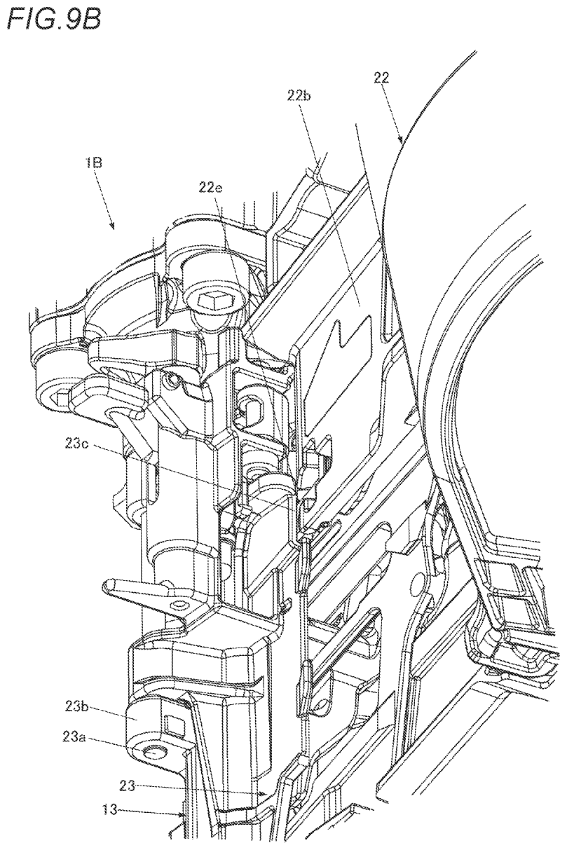

FIGS. 9A and 9B are perspective views of a main part illustrating an example of a nail gun according to a modification of the present embodiment, and FIG. 9A illustrates a state in which the cap portion can be opened. FIG. 9B illustrates a state in which the cap portion is held in the closed state.

In the nail gun 1A including the pressing portion 25, the pressing portion 25 moves to the release position at which the pressing of the cap portion 22 is released, whereby the pressing portion 25 retreats from the movement path of the engaged portion 22e in the operation of opening the cap portion 22. Accordingly, an amount of movement of the magazine 2 until the engagement between the engaged portion 22e and the engaging portion 23c is released is reduced. In addition, a force for holding the cap portion 22 in the closed state is dispersed by the engagement between the engaged portion 22e and the engaging portion 23c and a force by which the pressing portion 25 presses the cap portion 22. Therefore, even if a length of a portion at which the engaged portion 22e and the engaging portion 23c are engaged with each other is reduced, the force for holding the cap portion 22 in the closed state can be secured by the engagement between the engaged portion 22e and the engaging portion 23c. Therefore, by reducing a length of the engaged portion 22e, the amount of movement of the magazine 2 until the engagement between the engaged portion 22e and the engaging portion 23c is released is reduced.

On the other hand, a nail gun 1B according to the modification does not include the pressing portion 25, and thus the length of the portion at which the engaged portion 22e and the engaging portion 23c are engaged with each other is increased by increasing the length of the engaged portion 22e, and the force for holding the cap portion 22 in the closed state is secured by the engagement between the engaged portion 22e and the engaging portion 23c. The nail gun 1B does not include the pressing portion 25, and thus the number of components to be moved can be reduced.

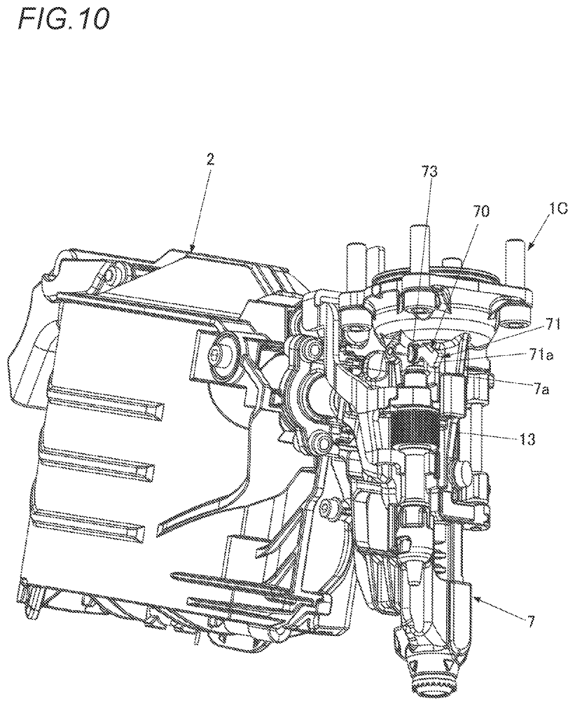

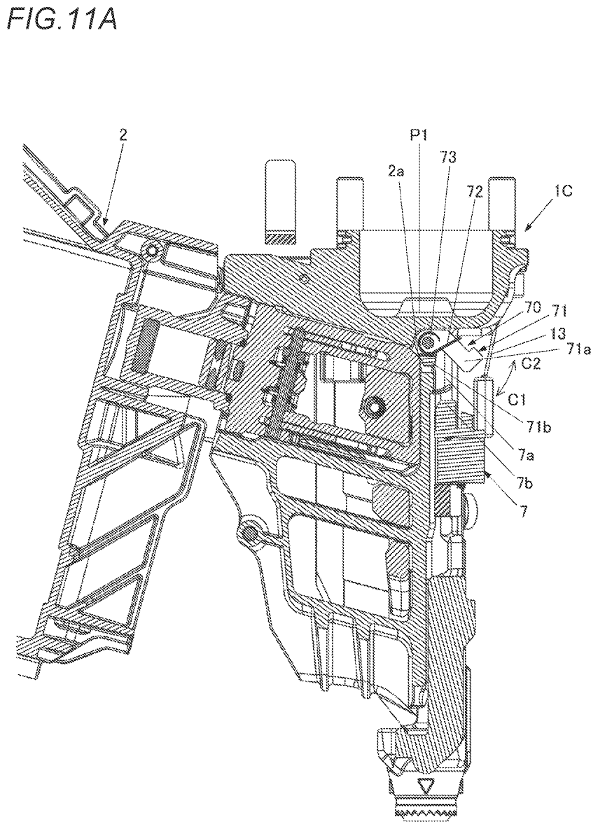

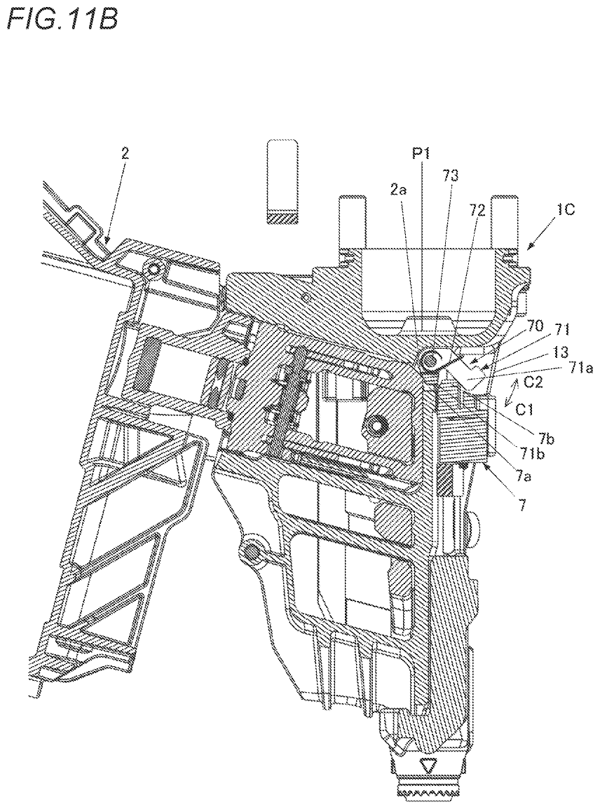

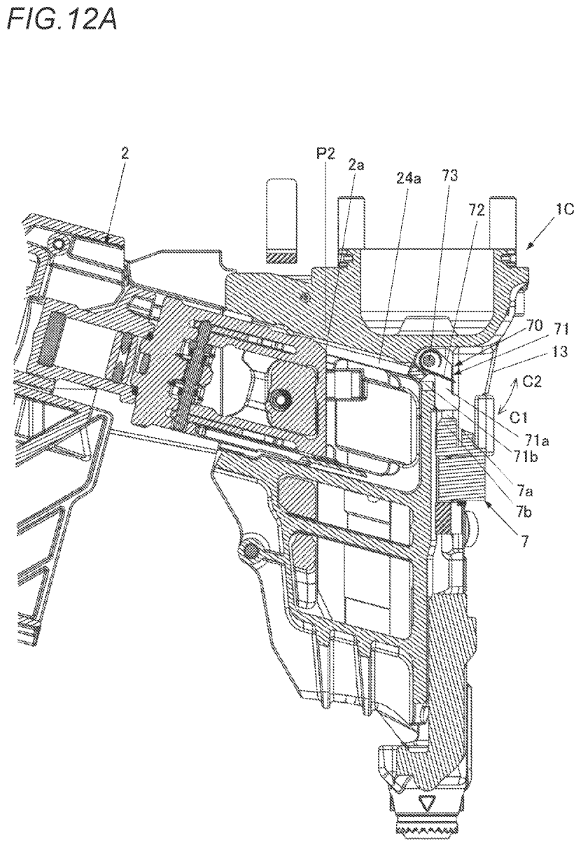

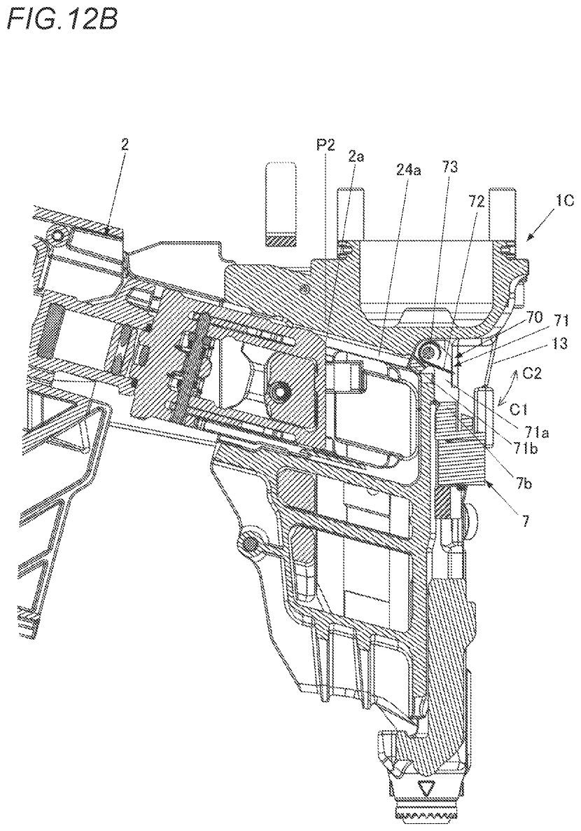

FIG. 10 is a perspective view of a main part illustrating an example of a nail gun according to a second embodiment, and FIGS. 11A, 11B, 12A, and 12B are side views of a main part illustrating the example of the nail gun according to the second embodiment. In a nail gun 1C according to the second embodiment, configurations similar to those of the nail gun 1A according to the first embodiment are denoted by the same reference numerals. FIGS. 11A and 11B illustrate a state in which the restriction of the movement of the contact portion 7 is released according to the position of the magazine 2, and FIGS. 12A and 12B illustrate a state in which the movement of the contact portion 7 is restricted according to the position of the magazine 2.

The nail gun 1C includes a contact restriction portion 70 that restricts the movement of the contact portion 7 according to the position of the magazine 2. The contact portion 7 is provided so as to be movable in a third direction along an extending direction of the injection passage 13a from a third position at which the starting valve 5 is not operable to a fourth position at which the starting valve 5 is operable as illustrated in FIG. 4A and the like, and is provided so as to be movable in a fourth direction opposite to the third direction from the fourth position to the third position. When the contact portion 7 is moving to the standby position, the starting valve 5 does not operate even when the trigger 6 is operated. Therefore, the third position is, for example, the standby position. However, the third position may be a position at which the contact portion 7 is moved in the third direction from the standby position as long as the starting valve 5 is in a non-operation range even when the trigger 6 is operated. In addition, when the contact portion 7 is moved to the top dead center position, the fourth position is, for example, the top dead center position as long as the contact portion 7 is brought into the sign-in state in which the starting valve 5 is operable. However, a configuration is also conceivable in which the contact portion 7 is moved in the third direction from the third position and is brought into the sign-in state at a position before reaching the top dead center position. Therefore, the fourth position may be a position at which the contact portion 7 is moved in the fourth direction from the top dead center position as long as the contact portion 7 is brought into the sign-in state. The contact portion 7 switches between the sign-off state in which the starting valve 5 is not operable at the third position and the sign-in state in which the starting valve 5 is operable by moving in the third direction from the third position to the fourth position. The contact restriction portion 70 restricts the movement of the contact portion 7 to the fourth position.

The contact restriction portion 70 includes a contact restriction lever 71 and a biasing member 72 that biases the contact restriction lever 71. The contact restriction lever 71 is supported by the nose portion 13 via a shaft 73 and rotates with the shaft 73 as a fulcrum. An axial direction in which the shaft 73 extends is a direction intersecting a direction in which the magazine 2 moves.

The contact portion 7 includes an engaged portion 7b that is engaged with the contact restriction lever 71. The engaged portion 7b is implemented by a portion located on the outer periphery of the nose portion 13 with which the injection passage 13a is covered in the contact portion 7. The magazine 2 includes an engaging portion 2a that causes the contact restriction lever 71 to operate. The engaging portion 2a is implemented by a portion supported by the magazine support portion 24 in the magazine 2. The engaging portion 2a moves integrally with the magazine 2 along the magazine support portion 24 in a direction separated from and in a direction approaching the nose portion 13.

The nail gun 1C includes a movement path 7a through which the engaged portion 7b passes. The movement path 7a is formed on the outer periphery of the nose portion 13 with which the injection passage 13a is covered at a portion along the extending direction of the injection passage 13a. The engaged portion 7b passes through the movement path 7a in the operation of moving the contact portion 7 in the third direction from the third position to the fourth position and an operation of moving the contact portion 7 in the fourth direction from the fourth position to the third position. The nail gun 1C includes a movement path 24a through which the engaging portion 2a passes. The movement path 24a is formed at a portion along the movement direction of the magazine 2 that moves by the guide of the magazine support portion 24. The engaging portion 2a passes through the movement path 24a in an operation of moving the magazine 2 in the first direction from the closed position P1 to the openable and closable position P2 and an operation of moving the magazine 2 in the second direction from the openable and closable position P2 to the closed position P1.

The contact restriction lever 71 includes a protruding portion 71a that protrudes and retreats from the movement path 7a of the contact portion 7 and can be engaged with the engaged portion 7b of the contact portion 7, and an engaged portion 71b that protrudes and retreats from the movement path 24a of the magazine 2 and can be engaged with and disengaged from the engaging portion 2a of the magazine 2. The protruding portion 71a has a shape extending from a portion supported by the shaft 73 in one direction intersecting the shaft 73. The engaged portion 71b has a shape extending from the portion supported by the shaft 73 in another direction that intersects the shaft 73 and is different from the one direction. In this example, the contact restriction lever 71 is configured such that the protruding portion 71a and the engaged portion 71b move in the same direction along the movement direction of the magazine 2. Therefore, in the contact restriction lever 71, for example, an angle formed by a direction in which the protruding portion 71a extends and a direction in which the engaged portion 71b extends is an acute angle. Accordingly, when the protruding portion 71a of the contact restriction lever 71 rotates with the shaft 73 as a fulcrum in an arrow C1 direction from the outside of the movement path 7a toward the movement path 7a, the protruding portion 71a and the engaged portion 71b move in the same arrow C1 direction. In addition, when the protruding portion 71a of the contact restriction lever 71 rotates with the shaft 73 as a fulcrum in an arrow C2 direction from the movement path 7a toward the outside of the movement path 7a, the protruding portion 71a and the engaged portion 71b move in the same arrow C2 direction.

The contact restriction lever 71 moves between a restriction position at which the movement of the contact portion 7 is restricted and a restriction release position at which the restriction of the movement of the contact portion 7 is released in a rotation operation with the shaft 73 as a fulcrum. That is, the contact restriction lever 71 moves to the restriction position by rotating in the arrow C1 direction from the restriction release position. When the contact restriction lever 71 moves to the restriction position, the direction in which the protruding portion 71a extends becomes a direction along a direction in which the contact portion 7 moves, and the contact restriction lever 71 moves to a position at which the protruding portion 71a protrudes to the movement path 7a. When the protruding portion 71a protrudes to the movement path 7a, for example, even when the contact portion 7 attempts to move in the third direction from the third position in an operation of pressing the contact portion 7 against the material to be driven (not shown), the engaged portion 7b of the contact portion 7 comes into contact with the protruding portion 71a, and the movement of the contact portion 7 to the fourth position is restricted. When the contact restriction lever 71 rotates in the same direction, the contact restriction lever 71 moves to a position at which the engaged portion 71b protrudes to the movement path 24a.

On the other hand, the contact restriction lever 71 moves to the restriction release position by rotating in the arrow C2 direction from the restriction position. When the contact restriction lever 71 moves to the restriction release position, the direction in which the protruding portion 71a extends becomes a direction inclined with respect to the direction in which the contact portion 7 moves, and the contact restriction lever 71 moves to a position at which the protruding portion 71a retreats outward from the movement path 7a. When the protruding portion 71a retreats outward from the movement path 7a, for example, when the contact portion 7 is moved in the third direction from the third position in the operation of pressing the contact portion 7 against the material to be driven (not shown), the engaged portion 7b of the contact portion 7 does not come into contact with the protruding portion 71a, and the restriction of the movement of the contact portion 7 to the fourth position is released. When the contact restriction lever 71 rotates in the same direction, the contact restriction lever 71 moves to a position at which the engaged portion 71b retreats outward from the movement path 24a.

The biasing member 72 is implemented by a torsion coil spring and the like, and biases the contact restriction lever 71 in the arrow C1 direction.

The engaging portion 2a moves along the movement path 24a in the operation of moving the magazine 2 from the closed position P1 to the openable and closable position P2 and the operation of moving the magazine 2 from the openable and closable position P2 to the closed position P1.

The engaging portion 2a moves in a direction approaching the engaged portion 71b of the contact restriction lever 71 in the operation of moving the magazine 2 in the second direction from the openable and closable position P2 to the closed position P1. Accordingly, when the magazine 2 is moved to the closed position P1, the engaging portion 2a is engaged with the engaged portion 71b of the contact restriction lever 71.

The engaging portion 2a moves in a direction separated from the engaged portion 71b of the contact restriction lever 71 in the operation of moving the magazine 2 in the first direction from the closed position P1 to the openable and closable position P2. Accordingly, when the magazine 2 is moved to the openable and closable position P2, the engagement between the engaging portion 2a and the engaged portion 71b of the contact restriction lever 71 is released.

Next, an operation of switching whether the movement of the contact portion 7 is restricted according to the position of the magazine 2 in the nail gun 1C according to the second embodiment will be described. In the nail gun 1C, the engaging portion 2a of the magazine 2 is engaged with the engaged portion 71b of the contact restriction lever 71 in the operation of moving the magazine 2 from the openable and closable position P2 to the closed position P1.

When the engaging portion 2a of the magazine 2 is engaged with the engaged portion 71b, the contact restriction lever 71 is pressed in a direction in which the engaged portion 71b retreats outward from the movement path 24a in the operation of moving the magazine 2 from the openable and closable position P2 to the closed position P1.

When the contact restriction lever 71 is pressed in the direction in which the engaged portion 71b retreats outward from the movement path 24a, the contact restriction lever 71 rotates in the arrow C2 direction with the shaft 73 as a fulcrum. Accordingly, when the magazine 2 is moved to the closed position P1, the contact restriction lever 71 moves to the restriction release position at which the protruding portion 71a retracts outward from the movement path 7a as illustrated in FIG. 11A. Therefore, when the contact portion 7 is moved in the third direction from the third position in the operation of pressing the contact portion 7 against the material to be driven (not shown), the engaged portion 7b of the contact portion 7 does not come into contact with the protruding portion 71a, and the contact portion 7 can move to the fourth position at which it is possible to perform the sign-in by which the starting valve 5 is operable.

Therefore, in a state in which the magazine 2 is moved to the closed position P1, the contact portion 7 is pressed against the material to be driven (not shown), whereby the contact portion 7 moves upward to be brought into the sign-in state as illustrated in FIG. 11B. When the trigger 6 is further operated, the nails can be driven by operating the starting valve 5 in cooperation with the operation of the contact portion 7 and the operation of the trigger 6.

On the other hand, in the nail gun 1C, in the operation of moving the magazine 2 from the closed position P1 to the openable and closable position P2, the engaging portion 2a of the magazine 2 is separated from the engaged portion 71b of the contact restriction lever 71, and the engagement between the engaged portion 71b and the engaging portion 2a is released.

When the engaging portion 2a of the magazine 2 moves in the direction separated from the engaged portion 71b, the contact restriction lever 71 can rotate in a direction in which the engaged portion 71b protrudes to the movement path 24a.

Accordingly, when the magazine 2 is moved from the closed position P1 to the openable and closable position P2, the contact restriction lever 71 rotates in the arrow C1 direction with the shaft 73 as a fulcrum by the biasing of the biasing member 72. Therefore, when the magazine 2 is moved to the openable and closable position P2, the contact restriction lever 71 moves to the restriction position at which the protruding portion 71a protrudes to the movement path 7a as illustrated in FIG. 12A. Therefore, when the contact portion 7 attempts to move in the third direction from the third position in the operation of pressing the contact portion 7 against the material to be driven (not shown), the engaged portion 7b of the contact portion 7 comes into contact with the protruding portion 71a, and the movement of the contact portion 7 to the fourth position is restricted.

As described above, when the magazine 2 is moved from the closed position P1 to the openable and closable position P2, the feeding member 80 moves from the feeding operation position P5 to the retracted position P6. When the feeding member 80 is moved to the retracted position P6, the leading nail 200 of the connected nails 200a engaged with the feeding member 80 is moved from the injection enable position P3 to the removable position P4. Accordingly, when the magazine 2 is moved to the openable and closable position P2, the leading nail 200 of the connected nails 200a is moved to a position at which the leading nail 200 is not driven even when the driver 32 is moved.

As described above, a case will be considered in which the contact portion 7 is brought into the sign-in state in the operation of attempting to move the contact portion 7 in the state in which the magazine 2 is moved to the openable and closable position P2, and the leading nail 200 of the connected nails 200a moves to the position at which the leading nail 200 is not driven even when the driver 32 is moved. In this case, when the trigger 6 is further operated, the starting valve 5 is operated to perform the operation of driving the nails 200 by the striking portion 3. When the driving operation is performed without the presence of the nail 200 in the movement path of the driver 32, the driving operation is referred to as so-called “idle driving”. In the nail gun, when the idle driving is performed, an overload may be applied to the striking portion 3, the nose portion 13, and the like.

Therefore, when the magazine 2 is moved to the openable and closable position P2, the movement of the contact portion 7 can be restricted by moving the contact restriction lever 71 to the restriction position. Accordingly, in the state in which the magazine 2 is moved to the openable and closable position P2, even when the contact portion 7 is pressed against the material to be driven (not shown), the movement of the contact portion 7 is restricted as illustrated in FIG. 12B. Therefore, the contact portion 7 is not brought into the sign-in state in the operation of attempting to move the contact portion 7, and the starting valve 5 does not operate even when the trigger 6 is operated. Therefore, it is possible to prevent an erroneous operation of the nail gun 1C such as idle driving. In the state in which the magazine 2 is moved to the openable and closable position P2, when the trigger 6 is operated, the contact portion 7 is brought into the sign-in state. However, the movement of the contact portion 7 is restricted, and thus the starting valve 5 does not operate in the operation of moving the contact portion 7. Therefore, it is possible to prevent an erroneous operation of the nail gun 1C such as idle driving.

In the state in which the contact restriction lever 71 moves to the restriction position, even when the contact portion 7 is pressed against the material to be driven (not shown), the contact portion 7 may move as long as the contact portion 7 is not in the sign-in state.

The contact restriction lever 71 rotates with the shaft 73 as a fulcrum, and the contact restriction lever 71 may move between the restriction position and the restriction release position in a linear movement along the movement direction of the magazine 2.

What is claimed is:

1. A driving tool, comprising:
a main body portion; and
a magazine that includes an accommodation portion configured to accommodate a fastener, and a cap portion that opens and closes the accommodation portion, and the magazine being movable in a first direction approaching the main body portion and a second direction separated from the main body portion, wherein
the main body portion includes an engaging portion engageable with the cap portion in a state where the cap portion is closed, and
the cap portion is engaged with the engaging portion by the magazine moving in the first direction, and is disengaged from the engaging portion by the magazine moving in the second direction from a state of being engaged with the engaging portion.

2. The driving tool according to claim 1, wherein
the main body portion includes a nose portion having an injection passage to which the fastener is supplied, and
the magazine is supported on the nose portion to be slidable in the first direction and the second direction.

3. The driving tool according to claim 2, wherein
the magazine includes a biasing member that biases the cap portion in an opening direction of the cap portion.

4. The driving tool according to claim 3, further comprising:
a feeding portion configured to feed the fastener to the injection passage, wherein
the feeding portion includes a feeding member that is engaged with the fastener to feed the fastener in the first direction, and
the feeding member is exposed to an outside in a state where the cap portion is opened.

5. The driving tool according to claim 4, wherein
the feeding member is interlocked with movement of the magazine.

6. The driving tool according to claim 5, wherein
the magazine movably supports the feeding portion.

7. The driving tool according to claim 2, wherein
the magazine includes a passage portion that is connected to the injection passage by moving in the first direction and is separated from the injection passage by moving in the second direction.

8. The driving tool according to claim 2, wherein
the nose portion includes a second passage portion that is connected to the injection passage such that the fastener passes through the second passage portion, and
the magazine includes a first passage portion through which the fastener passes and that is connected to the second passage portion by moving in the first direction and is separated from the second passage portion by moving in the second direction.

9. The driving tool according to claim 2, wherein
the nose portion further includes a pressing portion configured to press the closed cap portion, and
the pressing portion moves between a pressing position for pressing the cap portion and a release position for releasing the pressing of the cap portion in conjunction with movement of the magazine.

10. The driving tool according to claim 1, further comprising:
an operation unit configured to receive an operation of moving the magazine, wherein
the operation unit includes a holding unit configured to hold a position of the magazine.

11. The driving tool according to claim 10, wherein
the operation unit is configured to release a holding state where the holding unit holds the position of the magazine when receiving a force for moving the magazine in the second direction.

12. The driving tool according to claim 2, further comprising:
a striking portion configured to drive out the fastener by supplying compressed air;
a main valve configured to switch whether to supply the compressed air to the striking portion;
a starting valve configured to operate the main valve;
a contact portion that is provided to be movable from a third position at which the starting valve is not operable to a fourth position at which the starting valve is operable, and that is configured to switch between a sign-in state where the starting valve is operable by moving from the third position to the fourth position and a sign-off state where the starting valve is not operable at the third position; and
a contact restriction portion configured to restrict the contact portion from moving to the fourth position in accordance with a position of the magazine.

13. The driving tool according to claim 12, wherein
the contact restriction portion includes a contact restriction lever that protrudes to a movement path of the contact portion from the third position to the fourth position by the magazine moving in the second direction to restrict the contact portion moving, and that is configured to retreat from the movement path of the contact portion by the magazine moving in the first direction to release a restriction state where the contact restriction lever restricts the contact portion from moving.

14. The driving tool according to claim 1, wherein
the main body portion includes an openable and closable door portion provided with the engaging portion,
the cap portion includes an engaged portion configured to engage with the engaging portion, and
the magazine is configured to move in the second direction in a state where the door portion is closed.
